(19) United States
(12) Patent Application Publication
(10) Pub. No.: US 2018/0286423 A1
(43) Pub. Date: Oct. 4, 2018

(54) AUDIO PROCESSING DEVICE, AUDIO PROCESSING METHOD, AND PROGRAM

(71) Applicant: HONDA MOTOR CO., LTD., Tokyo (JP)

(72) Inventors: Kazuhiro Nakadai, Wako-shi (JP); Tomoyuki Sahata, Tokyo (JP)

(21) Appl. No.: 15/934,383

(22) Filed: Mar. 23, 2018

(30) Foreign Application Priority Data
Mar. 28, 2017 (JP) 2017-062795

(51) Int. Cl. G10L 21/028; G10L 21/0264; G10L 21/0216; G01S 3/80

(52) U.S. Cl. CPC G10L 21/028; G01S 3/8006; G10L 21/0216; G10L 21/0264

(57) ABSTRACT

An audio processing device includes a sound source localization unit that determines respective directions of sound sources from audio signals of a plurality of channels, a setting information selection unit that selects a setting information from a setting information storage unit that stores setting information including transfer functions of directions in advance for each acoustic environment, and a sound source separation unit that separates the audio signals of the plurality of channels into respective sound-source-specific signals of sound sources by applying a separation matrix based on transfer functions included in the setting information selected by the setting information selection unit.

### CROSS-REFERENCE TO RELATED APPLICATION

Priority is claimed on Japanese Patent Application No. 2017-062795, filed Mar. 28, 2017, the content of which is incorporated herein by reference.

### BACKGROUND OF THE INVENTION

### Field of the Invention

The present invention relates to an audio processing device, an audio processing method, and a program.

### Description of Related Art

Sound source separation technologies for separating audio signals in which signals generated by a plurality of unknown sound sources are mixed into components generated by the respective sound sources have been proposed in the related art.

Applications of the sound source separation technologies for various purposes have been proposed. Examples include preparation of minutes in a conversation or a conference among a plurality of speakers and support for the hearing-impaired by presenting text indicating speech content. When a voice recognition process is performed on the separated components, speech content of each speaker is expected as a processing result.

One of the sound source separation technologies is a blind source separation technology that does not require prior learning. For example, a sound source separation device described in Japanese Unexamined Patent Application, First Publication No. 2012-042953 (hereinafter referred to as Patent Document 1) estimates sound source directions on the basis of input signals of a plurality of channels and calculates a separation matrix on the basis of transfer functions relating to the estimated sound source directions. The sound source separation device multiplies the calculated separation matrix by an input signal vector having the input signals of channels as elements to calculate an output signal vector having output signals as elements. The elements of the calculated output signal vector indicate respective sounds of the sound sources.

### SUMMARY OF THE INVENTION

The sound source separation device described in Patent Document 1 specifies transfer functions corresponding to the estimated sound source directions such that a cost function based on one or both of separation sharpness and geometric constraint functions decreases and calculates a separation matrix corresponding to the specified transfer functions. The transfer functions used to calculate an initial value of the separation matrix do not necessarily approximate transfer functions in an environment in which the sound source separation device is installed. Therefore, with the calculated separation matrix, sometimes, it is not possible to achieve separation into respective components of sound sources or it takes time to obtain the separated components. On the other hand, measuring transfer functions in the installation environment imposes a measurement-related burden on the user. This is contrary to the user's desire to immediately use the sound source separation device.

An aspect of the present invention has been made in view of the above points and it is an object of the present invention to provide an audio processing device, an audio processing method, and a program which can more securely achieve separation into respective components of sound sources in an installation environment.

In order to achieve the above object, the present invention adopts the following aspects.

(1) An audio processing device according to an aspect of the present invention includes a sound source localization unit configured to determine respective directions of sound sources from audio signals of a plurality of channels, a setting information selection unit configured to select a setting information from a setting information storage unit configured to store setting information including transfer functions of directions in advance for each acoustic environment, and a sound source separation unit configured to separate the audio signals of the plurality of channels into respective sound-source-specific signals of sound sources by applying a separation matrix based on transfer functions included in the setting information selected by the setting information selection unit.

(2) In the above aspect (1), at least one of a shape, a size, and a wall surface reflectance of a space in which sound sources are installed may differ for each of the acoustic environments.

(3) In the above aspect (1) or (2), the setting information selection unit may be configured to cause a display unit to display information indicating acoustic environments and to select setting information corresponding to one of the acoustic environments on the basis of an operation input.

(4) In any one of the above aspects (1) to (3), the setting information selection unit may be configured to record history information indicating the selected setting information, to count a frequency of selection of each setting information on the basis of the history information, and to select the setting information from the setting information storage unit on the basis of the counted frequency.

(5) In any one of the above aspects (1) to (4), the setting information may include background noise information regarding a background noise characteristic in the acoustic environment and the setting information selection unit may be configured to analyze a background noise characteristic in a collected audio signal and to select the setting information from the setting information storage unit on the basis of the analyzed background noise characteristic.

(6) In any one of the above aspects (1) to (5), the audio processing device may further include a position information acquisition unit configured to acquire a position of the audio processing device and the setting information selection unit may be configured to select setting information corresponding to an acoustic environment at the position.

(7) In any one of the above aspects (1) to (6), the setting information selection unit may be configured to determine an amount of speech emphasis included in each of the sound-source-specific signals on the basis of an operation input.

(8) An audio processing method according to an aspect of the present invention is an audio processing method for an audio processing device including a sound source localization process including determining respective directions of sound sources from audio signals of a plurality of channels, a setting information selection process including selecting a setting information from a setting information storage unit configured to store setting information including transfer functions of directions in advance for each acoustic environment, and a sound source separation process including separating the audio signals of the plurality of channels into respective sound-source-specific signals of sound sources by applying a separation matrix based on transfer functions included in the setting information selected in the setting information selection process.

(9) A program according to an aspect of the present invention causes a computer for an audio processing device to perform a sound source localization procedure including determining respective directions of sound sources from audio signals of a plurality of channels, a setting information selection procedure including selecting a setting information from a setting information storage unit configured to store setting information including transfer functions of directions in advance for each acoustic environment, and a sound source separation procedure including separating the audio signals of the plurality of channels into respective sound-source-specific signals of sound sources by applying a separation matrix based on transfer functions included in the setting information selected in the setting information selection procedure.

According to the above aspect (1), (8), or (9), transfer functions acquired in any acoustic environment can be selected from transfer functions used to calculate separation matrices acquired in various acoustic environments. By switching to the selected transfer functions, it is possible to suppress a failure in the sound source separation or a reduction in the accuracy of sound source separation due to the use of fixed transfer functions.

According to the above aspect (2), transfer functions corresponding to one of the shape, the size, and the wall surface reflectance of the space, which are acoustic environment variation factors, are set. Therefore, it is possible to easily select transfer functions by using the shape, the size, and the wall surface reflectance of the space, which are the variation factors, as clues.

According to the above aspect (3), the user can arbitrarily select transfer functions used to calculate the separation matrix by referring to the acoustic environment without performing a complicated setting task.

According to the above aspect (4), without the user performing a special operation, it is possible to select transfer functions included in a piece of setting information on the basis of the frequency of selection of the piece of setting information in the past. In the case in which a piece of setting information including transfer functions giving high sound source separation accuracy in the operating environment of the audio processing device 1 has been frequently selected in the past, it is possible to suppress a failure in the sound source separation or a reduction in the accuracy of sound source separation by using the selected transfer functions.

According to the above aspect (5), transfer functions acquired in an acoustic environment having a background noise characteristic approximate to the background noise characteristic of the operating environment of the audio processing device 1 are selected without the user performing a special operation. Therefore, it is possible to reduce an influence due to differences in background noise between acoustic environments and thus it is possible to suppress a failure in the sound source separation or a reduction in the accuracy of sound source separation.

According to the above aspect (6), transfer functions corresponding to the acoustic environment in the operating environment of the audio processing device 1 are used for sound source separation without the user performing a special operation. Therefore, it is possible to suppress a failure in the sound source separation or a reduction in the accuracy of sound source separation.

According to the above aspect (7), it is possible to arbitrarily adjust the amount of reverberation or noise suppression as the amount of speech emphasis designated in the setting information.

### BRIEF DESCRIPTION OF THE DRAWINGS

FIG. 1 is a block diagram showing an exemplary configuration of an audio processing device according to a first embodiment.

FIG. 2 is a conceptual diagram showing exemplary profile data according to the first embodiment.

FIG. 3 is a flowchart showing an exemplary profile data setting procedure according to the first embodiment.

FIG. 4 is a diagram showing an exemplary profile data selection screen according to the first embodiment.

FIG. 5 is a flowchart showing audio processing according to the first embodiment.

FIG. 6 is a flowchart showing a first example of profile selection according to the first embodiment.

FIG. 7 is a flowchart showing a second example of profile selection according to the first embodiment.

FIG. 8 is a flowchart showing a third example of profile selection according to the first embodiment.

FIG. 9 is a flowchart showing a fourth example of profile selection according to the first embodiment.

FIG. 10 is a flowchart showing an exemplary parameter setting procedure according to the first embodiment.

FIG. 11 is a block diagram showing an exemplary configuration of an audio processing device according to a second embodiment.

FIG. 12 is a flowchart showing an example of profile selection according to the second embodiment.

### DETAILED DESCRIPTION OF THE INVENTION

### First Embodiment

Hereinafter, a first embodiment of the present invention will be described with reference to the drawings.

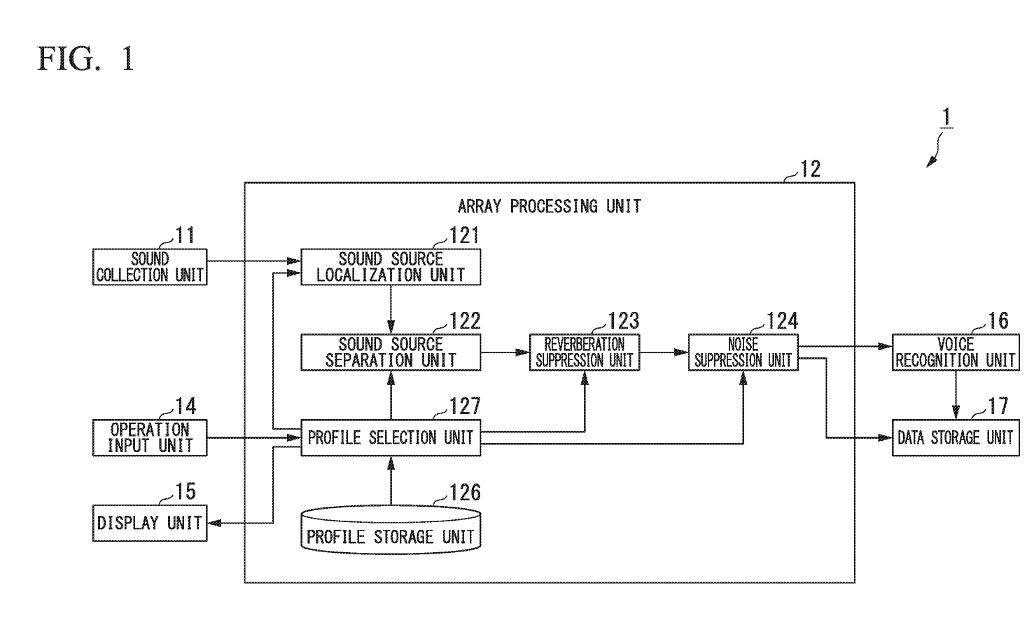

FIG. 1 is a block diagram showing an exemplary configuration of an audio processing device 1 according to the present embodiment.

The audio processing device 1 includes a sound collection unit 11, an array processing unit 12, an operation input unit 14, a display unit 15, a voice recognition unit 16, and a data storage unit 17.

The sound collection unit 11 collects audio signals of N channels (N: integer of 2 or more) and outputs the collected audio signals to the array processing unit 12. For example, the sound collection unit 11 includes N microphones and is a microphone array in which the microphones are arranged. Each of the microphones records an audio signal of one channel. The sound collection unit 11 may transmit the collected audio signals wirelessly or by wire. The sound collection unit 11 may be fixed in position or may be installed on a moving body such as a vehicle, an aircraft, or a robot such that the sound collection unit 11 is movable. The sound collection unit 11 may be integrated with or separated from the audio processing device 1.

The array processing unit 12 determines respective directions of sound sources on the basis of audio signals input from the sound collection unit 11. The array processing unit 12 selects one of a plurality of pieces of preset setting information and calculates a separation matrix such that a predetermined cost function decreases on the basis of transfer functions relating to the directions of sound sources included in the selected setting information. The array processing unit 12 applies the calculated separation matrix to the input audio signals to generate sound-source-specific signals. The array processing unit 12 performs predetermined post-processing on the respective sound-source-specific signals of sound sources and outputs the processed sound-source-specific signals to the voice recognition unit 16 and the data storage unit 17. The post-processing includes, for example, one or both of a reverberation suppression process and a noise suppression process as a process for relatively emphasizing speech components included in the sound-source-specific signals. The configuration of the array processing unit 12 will be described later.

The operation input unit 14 receives an operation of a user and outputs an operation signal corresponding to the received operation to the array processing unit 12 or other functional units. The operation input unit 14 may be formed of a dedicated member such as a button or a lever or may be formed of a general-purpose member such as a touch sensor.

The display unit 15 displays information indicated by display signals input from the array processing unit 12 and other functional units. The display unit 15 is, for example, a liquid crystal display, an organic electro-luminescence (EL) display, or the like. When the operation input unit 14 is a touch sensor, the operation input unit 14 and the display unit 15 may be configured as a single touch panel into which the two units are integrated.

The voice recognition unit 16 performs a voice recognition process on the respective sound-source-specific signals of sound sources input from the array processing unit 12 and generates speech data indicating speech content as a recognition result. The voice recognition unit 16 calculates an acoustic feature amount for each sound-source-specific signal at predetermined time intervals (for example, at intervals of 10 ms), calculates a first likelihood of each possible phoneme string for the calculated acoustic feature amount using a preset acoustic model, and determines a predetermined number of candidate phoneme strings in descending order of the first likelihood. The acoustic model is, for example, a hidden Markov model (HMM). The voice recognition unit 16 calculates a second likelihood of a candidate sentence indicating speech content corresponding to the determined candidate phoneme string for each candidate phoneme string using a predetermined language model. The language model is, for example, n-gram. The voice recognition unit 16 calculates a total likelihood obtained by combining the first and second likelihoods for each candidate sentence and determines a candidate sentence having the highest total likelihood as speech content. The voice recognition unit 16 outputs speech data indicating the determined speech content to the data storage unit 17.

The data storage unit 17 stores various types of data acquired by the audio processing device 1 and various types of data used for processing performed by the audio processing device 1. The data storage unit 17 stores one or both of a sound-source-specific signal of each sound source input from the array processing unit 12 and speech data input from the voice recognition unit 16. The type of data to be stored depends on the operating mode. When the operating mode is a voice recognition mode, the data storage unit 17 stores speech data of each sound source. When the operating mode is a recording mode, the data storage unit 17 stores a sound-source-specific signal of each sound source. When the operating mode is a conference mode, the data storage unit 17 stores a sound-source-specific signal and speech data in association with each sound source. Each piece of speech content indicated by the speech data may be associated with a sound-source-specific signal of speech indicating the piece of the speech content. Of the functions of the audio processing device 1, for example, a function indicated by an operation signal input from the operation input unit 14 is indicated as the operating mode.

It is to be noted that some or all of the sound collection unit 11, the operation input unit 14, and the display unit 15 are not necessarily integrated with the other functional units of the audio processing device 1 as long as various data can be input or output wirelessly or by wire to or from the sound collection unit 11, the operation input unit 14, and the display unit 15.

The audio processing device 1 may be a dedicated device or may be configured as a part of a device which mainly has other functions. For example, the audio processing device 1 may be realized as a part of a mobile terminal device such as a multifunctional mobile phone (including a so-called smartphone) or a tablet terminal device or another electronic device.

Next, the configuration of the array processing unit 12 will be described. The array processing unit 12 includes a sound source localization unit 121, a sound source separation unit 122, a reverberation suppression unit 123, a noise suppression unit 124, a profile storage unit 126, and a profile selection unit 127.

The sound source localization unit 121 performs a sound source localization process on the audio signals of N channels input from the sound collection unit 11 at intervals of a predetermined period (for example, at intervals of 50 ms) to estimate a maximum number, M, of sound sources (where M is an integer of 1 or more and less than N). The sound source localization process is, for example, a multiple signal classification (MUSIC) method.

The MUSIC method is a method of calculating a MUSIC spectrum as a spatial spectrum indicating an intensity distribution of directions and determining a direction at which the calculated MUSIC spectrum is peaked as a sound source direction as will be described later. In general, there are a plurality of directions at which the spatial spectrum has peaks due to reflected sound or various noises. Therefore, the sound source localization unit 121 adopts directions at which the spatial spectrum is higher than a predetermined threshold value as candidates for the sound source direction and rejects directions at which the spatial spectrum is equal to or less than the threshold value from the candidates for the sound source direction. That is, the threshold value of the spatial spectrum corresponds to a sound source detection parameter for adjusting the power of a sound source to be detected. In the present embodiment, the sound source localization unit 121 uses a sound source detection parameter and a set of transfer functions determined by the profile selection unit 127 for estimating the sound source direction. The sound source localization unit 121 outputs sound source localization information indicating the estimated sound source direction and the audio signals of N channels to the sound source separation unit 122.

The sound source separation unit 122 performs a sound source separation process on the audio signals of the N channels using transfer functions of each sound source direction indicated by the sound source localization information input from the sound source localization unit 121. The sound source separation unit 122 uses, for example, a geometric-constrained high-order decorrelation-based source separation (GHDSS) method as the sound source separation process. The sound source separation unit 122 specifies transfer functions relating to the sound source direction indicated by the sound source localization information from a preset set of the transfer functions of each direction and calculates an initial value of the separation matrix (hereinafter referred to as an initial separation matrix) on the basis of the specified transfer functions. The sound source separation unit 122 cyclically calculates a separation matrix such that a predetermined cost function calculated from the transfer functions and the separation matrix decreases. The sound source separation unit 122 multiplies an input signal vector which has the respective audio signals of channels as elements by the calculated separation matrix to calculate an output signal vector. Elements of the calculated output signal vector correspond to the respective sound-source-specific signals of sound sources. The sound source separation unit 122 outputs the sound-source-specific signal of each sound source to the reverberation suppression unit 123. In the present embodiment, the sound source localization unit 121 uses a set of transfer functions determined by the profile selection unit 127 to estimate the sound source directions. The set of transfer functions determined by the profile selection unit 127 is set in the sound source separation unit 122. Thus, the set transfer functions are used when calculating the initial separation matrix.

The reverberation suppression unit 123 performs a reverberation suppression process on the sound-source-specific signal of each sound source input from the sound source separation unit 122. The reverberation suppression unit 123 uses, for example, a spectral subtraction method as the reverberation suppression process. The spectral subtraction method is a method of subtracting the power of a reverberation component from the power of an input signal for each frequency band to calculate the power of a reverberation-suppressed signal. The power of the reverberation component is obtained by multiplying the power of the input signal by a reverberation suppression coefficient. This reverberation suppression coefficient corresponds to a reverberation suppression parameter for adjusting the degree of suppressing reverberation as an unnecessary component. In the present embodiment, the reverberation suppression unit 123 uses the reverberation suppression parameter determined by the profile selection unit 127 for the reverberation suppression process. The reverberation suppression unit 123 outputs the sound-source-specific signal of each sound source obtained by performing the reverberation suppression process to the noise suppression unit 124.

The noise suppression unit 124 performs a noise suppression process on the sound-source-specific signal of each sound source input from the reverberation suppression unit 123. In the present embodiment, the noise suppression process mainly refers to a noise suppression process for suppressing background noise. The noise suppression unit 124 uses, for example, a histogram-based recursive level estimation (HRLE) method as the noise suppression process. The HRLE method is a method in which the power of each frequency is sequentially calculated for an input signal, a histogram indicating a frequency distribution of each power is generated, and a power whose cumulative frequency has reached a predetermined threshold value is determined as the power of background noise. This threshold value corresponds to a noise suppression parameter for adjusting the degree of suppressing background noise. In the present embodiment, the noise suppression unit 124 uses the noise suppression parameter determined by the profile selection unit 127 for suppressing noise. The noise suppression unit 124 outputs the sound-source-specific signal of each sound source obtained by performing the noise suppression process to one or both of the voice recognition unit 16 and the data storage unit 17. The output destination of the sound-source-specific signal depends on the operating mode. When the operating mode is the voice recognition mode, the output destination is the voice recognition unit 16. When the operating mode is the recording mode, the output destination is the data storage unit 17. When the operating mode is the conference mode, the output destination is both the voice recognition unit 16 and the data storage unit 17.

Profile data indicating the respective acoustic characteristics of a plurality of acoustic environments is stored in advance in the profile storage unit 126. The profile data is setting information configured to include a set of transfer functions of each sound source direction with respect to the sound collection unit 11, a sound source detection parameter, a noise suppression parameter, and a reverberation suppression parameter in each of the acoustic environments. At least one of information elements such as the shape, the size, and the wall surface reflectance of a space in which various sound sources are installed and sounds generated by the sound sources propagate differs for each of the plurality of acoustic environments. An example of the profile data will be described later.

The profile selection unit 127 determines profile data relating to one acoustic environment among respective profile data of the plurality of acoustic environments stored in the profile storage unit 126. The profile selection unit 127 outputs a set of transfer functions included in the determined profile data to the sound source localization unit 121 and the sound source separation unit 122. The profile selection unit 127 may adjust at least one of a sound source detection parameter, a noise suppression parameter, and a reverberation suppression parameter included in the determined profile data. The profile selection unit 127 outputs acquired sound source detection, noise suppression, and reverberation suppression parameters to the sound source localization unit 121, the noise suppression unit 124, and the reverberation suppression unit 123, respectively. A specific example of the profile selection will be described later.

### (Profile Data)

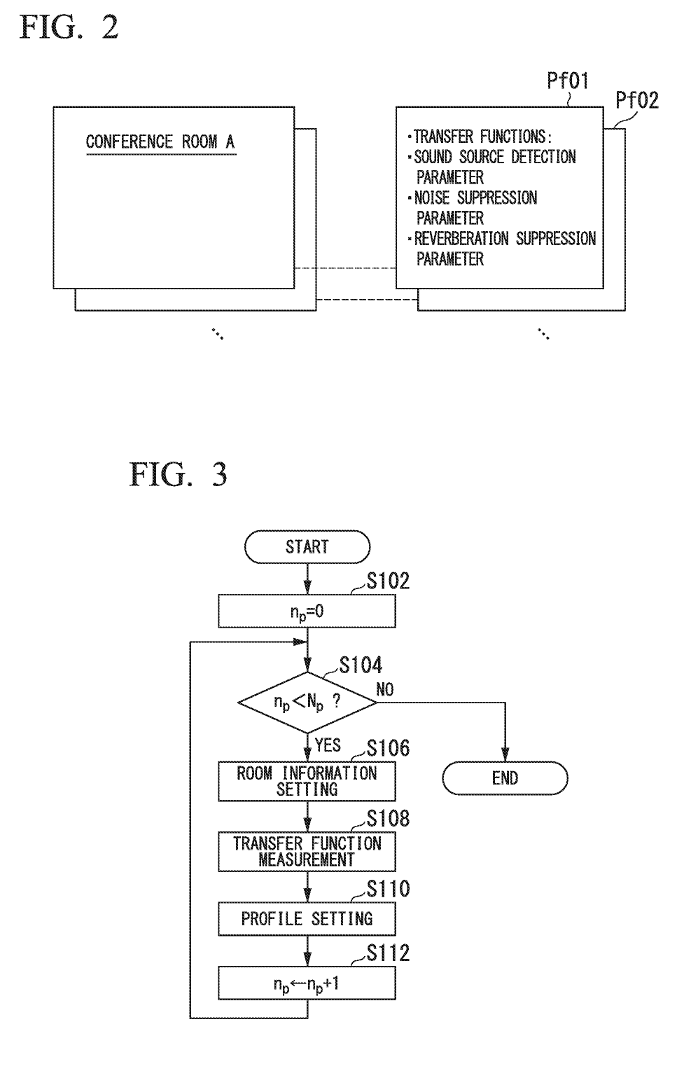

Next, profile data according to the present embodiment will be described. FIG. 2 is a conceptual diagram showing exemplary profile data according to the present embodiment. The profile data is data indicating the acoustic characteristics of each acoustic environment. As the acoustic characteristics, the data includes a set of transfer functions of each direction with respect to the sound collection unit 11, a sound source detection parameter, a noise suppression parameter, and a reverberation suppression parameter in the acoustic environment. The set of transfer functions includes, for example, transfer functions from a sound source installed in each direction within a predetermined radius from a representative point of the sound collection unit 11 to microphones which constitute the sound collection unit 11. The representative point is, for example, the center of gravity of the positions of the microphones. The sound source detection parameter is set to detect directions at which peaks of the spatial spectrum are higher than the set value of the parameter as candidate sound source directions in the sound source localization process. Generally, in acoustic environments in which reverberation is more significant, peaks of the spatial spectrum are smaller and therefore the sound source detection parameter is set such that the threshold value of the spatial spectrum is lower. The noise suppression parameter is a parameter for adjusting the degree of noise suppression. The type of noise suppression parameter depends on the processing method. However, in general, there is a tendency for a greater degree of noise suppression to result in greater distortion of the processed audio signal. The reverberation suppression parameter is a parameter for adjusting the degree of reverberation suppression. The type of reverberation suppression parameter depends on the processing method. However, in general, there is a tendency for a greater degree of the reverberation suppression to result in greater distortion of the processed audio signal.

Further, information regarding the name and type of a corresponding room may be used as identification information indicating an acoustic environment which is associated with the profile data. In the example shown in FIG. 2, “conference room A” indicating profile data Pf01 is used as identification information.

### (Setting of Profile Data)

Next, a profile data setting procedure according to the present embodiment will be described.

FIG. 3 is a flowchart showing an exemplary profile data setting procedure according to the present embodiment. Before starting an on-line operation of the audio processing device 1, the profile data setting procedure is performed in advance off-line.

The following description will be given with reference to an example in which the array processing unit 12 performs the procedure shown in FIG. 3, but various types of measurement and data collection in the acoustic environment may be performed by a device separate from the audio processing device 1.

(Step S102) The array processing unit 12 sets an initial value of a count number nₚ indicating the number (count) of pieces of profile data processed up to the current time to 0. Thereafter, the array processing unit 12 proceeds to a process of step S104.

(Step S104) The array processing unit 12 determines whether or not the count number nₚ is less than a predetermined total number, Nₚ, of pieces of profile data. Upon determining that the count number nₚ is less than Nₚ (step S104: YES), the array processing unit 12 proceeds to a process of step S106. Upon determining that the count number nₚ is Nₚ or more (step S104: NO), the array processing unit 12 ends the procedure shown in FIG. 3.

(Step S106) The array processing unit 12 sets room information indicating a room as an acoustic environment in which profile data is to be acquired. Thereafter, the array processing unit 12 proceeds to a process of step S108.

(Step S108) The array processing unit 12 measures transfer functions of each frequency for each sound source direction from a corresponding sound source to the microphones of the sound collection unit 11. Thereafter, the array processing unit 12 proceeds to a process of step S110.

(Step S110) The array processing unit 12 integrates a set of transfer functions including the transfer functions measured for each sound source direction with a set of audio processing parameters determined in the acoustic environment to generate profile data. The audio processing parameters include a sound source detection parameter, a noise suppression parameter, and a reverberation suppression parameter. A spatial spectrum value which is significantly higher than spatial spectrum values caused by background noise and reverberation and which is within a range in which detection of a sound source to be reproduced does not fail is determined as the sound source detection parameter. A value which gives the best subjective sound quality considering both sound quality improvement due to the suppression of background noise components included in the sound-source-specific signals obtained by the sound source separation process and sound quality deterioration due to distortion is indicated as the noise suppression parameter by an operation signal. A value which gives the best subjective sound quality considering both sound quality improvement due to the suppression of reverberation components included in the sound-source-specific signals obtained by the reverberation suppression process and sound quality deterioration due to distortion is indicated as the reverberation suppression parameter by an operation signal. The array processing unit 12 stores the generated profile data and acoustic environment information in the profile storage unit 126 in association with each other.

Thereafter, the array processing unit 12 proceeds to a process of step S112.

(Step S112) The array processing unit 12 adds 1 to the count number nₚ at that time to obtain a new count number nₚ. Thereafter, the array processing unit 12 returns to process of step S104.

### (Profile Data Selection Screen)

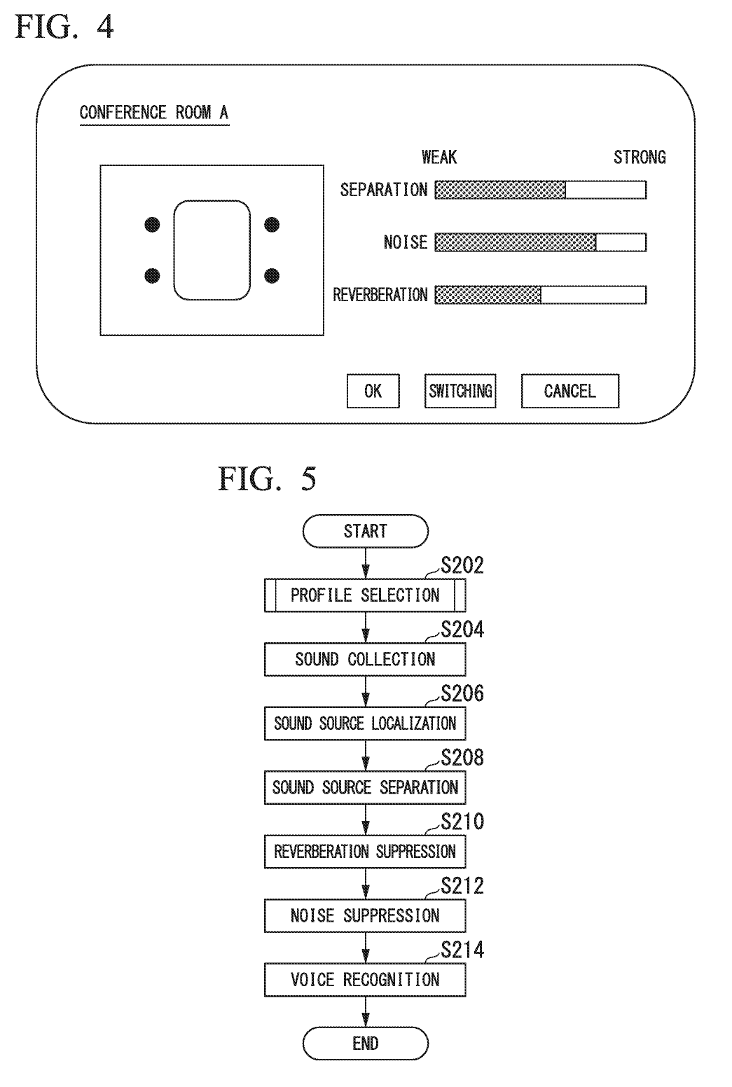

Next, a profile data selection screen according to the present embodiment will be described. FIG. 4 is a diagram showing an exemplary profile data selection screen according to the present embodiment.

The profile selection unit 127 causes the display unit 15 to display the profile data selection screen upon initial activation or when an operation signal indicating display of the selection screen is input. The selection screen includes acoustic environment information associated with a piece of profile data. In the example shown in FIG. 4, the acoustic environment information includes a character string “conference room A” as its title and a diagram showing a conference room as the type of room. The acoustic environment information may include information indicating any one or combination of the shape, the size, and the wall surface material of room.

Information of audio processing parameters included in profile data associated with the audio environment information may also be set on the selection screen. In the example shown in FIG. 4, the values of a sound source detection parameter, a noise suppression parameter, and a reverberation suppression parameter are indicated in rows, to which character strings “separation,” “noise,” and “reverberation” are assigned, by the respective lengths of filled portions of slider bars. The positions of a pointer shown at the right end of the filled portion of each audio processing parameter that are farther to the right indicate greater indicated values of the audio processing parameter. The profile selection unit 127 may specify the position of a pointer as indicated by an operation signal and change the original value of a corresponding audio processing parameter to a value of the audio processing parameter corresponding to the specified position. Thus, the values of the audio processing parameters can be arbitrarily adjusted by the user's operation.

Further, an “OK” button, a “switching” button, and a “cancel” button are displayed on the selection screen.

When the “OK” button is pressed, the profile selection unit 127 outputs a set of transfer functions included in the profile data corresponding to the acoustic environment information included in the selection screen displayed at that time to the sound source localization unit 121 and the sound source separation unit 122. Here, the profile selection unit 127 outputs the sound source detection parameter, the noise suppression parameter, and the reverberation suppression parameter set at that time to the sound source localization unit 121, the noise suppression unit 124, and the reverberation suppression unit 123, respectively. Here, “pressed” means that an operation signal indicating a position in a display area of the button or the like is input in addition to indicating that the button is actually pressed.

When the “switching” button is pressed, the profile selection unit 127 specifies profile data different from the profile data relating to the acoustic environment information and the audio processing parameters included in the selection screen displayed at that time. Then, the profile selection unit 127 changes the acoustic environment information and the audio processing parameters included at that time to acoustic environment information and audio processing parameters relating to the specified profile data. Therefore, each time the “switching” button is pressed, the profile data is sequentially switched to different profile data.

When the “cancel” button is pressed, the profile selection unit 127 deletes the selection screen being displayed at that time.

It is to be noted that the profile selection unit 127 may cause the display unit 15 to display a title list representing titles relating to individual pieces of profile data. The profile selection unit 127 may specify profile data relating to a pressed title among the titles included in the title list. The profile selection unit 127 may output a set of transfer functions included in the specified profile data to the sound source localization unit 121 and the sound source separation unit 122 and output a sound source detection parameter, a noise suppression parameter, and a reverberation suppression parameter included in the profile data to the sound source localization unit 121, the noise suppression unit 124, and the reverberation suppression unit 123, respectively. The profile selection unit 127 may also display a screen for selecting the specified profile data.

### (Sound Source Localization Process)

Next, a sound source localization process using the MUSIC method will be described as an exemplary sound source localization process.

The sound source localization unit 121 sets the set of transfer functions input from the profile selection unit 127.

The sound source localization unit 121 performs a discrete Fourier transform on the respective audio signals of channels input from the sound collection unit 11 on a frame basis to calculate transform coefficients converted into the frequency domain. The sound source localization unit 121 generates an input vector x which has the respective transform coefficients of channels as elements for each frequency. The sound source localization unit 121 calculates a spectral correlation matrix Rₛₚ shown in expression (1) on the basis of the input vector.

Rₛₚ=E[xx*] (1)

In expression (1), * denotes a complex conjugate transpose operator. E( . . . ) indicates an expected value of . . . .

The sound source localization unit 121 calculates eigenvalues λᵢ and eigenvectors eᵢ that satisfy expression (2) for the spectral correlation matrix Rₛₚ.

Rₛₚeᵢ=λᵢeᵢ (2)

The index i is an integer of 1 or more and N or less. The order of indices i is a descending order of eigenvalues λᵢ.

The sound source localization unit 121 calculates a spatial spectrum P(θ) shown in expression (3) on the basis of a transfer function vector d(θ) and the eigenvectors ei. The transfer function vector d(θ) is a vector whose elements are transfer functions from a sound source installed in the sound source direction θ to the respective microphones of channels. Therefore, from the set of transfer functions that has been set, the sound source localization unit 121 extracts respective transfer functions of channels relating to the direction θ as elements of the transfer function vector d(θ).

$$P ( θ ) = \frac{\vert {d}^{*} ( θ ) d ( θ ) \vert}{{\sum }_{i = M + 1}^{K} \vert {d}^{*} ( θ ) {e}_{i} \vert} \qquad ( 3 )$$

In expression (3), | . . . | represents an absolute value of M is a preset positive integer less than N indicating the maximum number of detectable sound sources. K is the number of eigenvectors et held by the sound source localization unit 121. M is a positive integer less than N. That is, the eigenvectors et (M+1≤i≤K) are vector values relating to significant components other than sound sources, for example, noise components. Therefore, the spatial spectrum P(θ) indicates the ratio of the components coming from sound sources to the significant components other than sound sources.

The sound source localization unit 121 calculates a signal-to-noise ratio (S/N ratio) for each frequency band on the basis of the audio signal of each channel and selects frequency bands k, the calculated S/N ratios of which are higher than a preset threshold value.

The sound source localization unit 121 sums spatial spectrums Pₖ(θ) of the selected frequency bands k, each weighted by the square root of the largest maximum eigenvalue λₘₐₓ(k) among eigenvalues λᵢ calculated for all frequencies of the corresponding frequency band k, to calculate an extended space spectrum Pₑₓₜ(θ) shown in expression (4).

$${P}_{ext} ( θ ) = \frac{1}{\vert Ω \vert} {\sum }_{k < Ω} \sqrt{{λ}_{max} ( k )} {P}_{k} ( θ ) \qquad ( 4 )$$

In expression (4), Ω represents a set of frequency bands. |Ω| indicates the number of frequency bands in the set. Therefore, the extended spatial spectrum Pₑₓₜ(θ) reflects the characteristics of frequency bands in which noise components are relatively small and the values of the spatial spectrum Pₖ(θ) are great.

This extended spatial spectrum Pₑₓₜ(θ) corresponds to the spatial spectrum described above.

The sound source localization unit 121 selects directions θ in which the extended spatial spectrum Pₑₓₜ(θ) is equal to or greater than a threshold value given as the set sound source detection parameter and has peak values (maximal values) from among the directions. The selected directions θ are estimated as sound source directions. That is, sound sources located in the selected directions θ are detected. The sound source localization unit 121 selects at most M highest peak values counted from the maximum value thereof from the peak values of the extended spatial spectrum Pₑₓₜ(θ) and selects sound source directions θ corresponding to the selected peak values. The sound source localization unit 121 outputs sound source localization information indicating the selected sound source directions to the sound source separation unit 122.

When estimating the direction of each sound source, the sound source localization unit 121 may use any method other than the MUSIC method, for example, a weighted delay and sum beam forming (WDS-BF) method.

### (Sound Source Separation Process)

Next, a sound source separation process using the GHDSS method will be described as an exemplary sound source separation process.

In the GHDSS method, a separation matrix W is calculated adaptively such that a cost function J(W) decreases and an output vector y obtained by multiplying the input vector x by the calculated separation matrix W is determined as transform coefficients of the sound-source-specific signals which indicate the respective components of the sound sources. The cost function J(W) is a weighted sum of a separation sharpness J_{SS}(W) and a geometric constraint J_{GC}(W) as shown in expression (5).

J(W)=αJ_{SS}(W)+_{GC}(W) (5)

Here, α denotes a weighting coefficient indicating the degree of contribution of the separation sharpness J_{SS}(W) to the cost function J(W).

The separation sharpness J_{SS}(W) is an index value shown in expression (6).

J_{SS}(W)=|E(yy*−diag(yy*)|² (6)

Here, | . . . |² indicates the Frobenius norm. The Frobenius norm is the sum of squares of the values of elements of a matrix. diag( . . . ) indicates the sum of diagonal elements of matrix . . . . That is, the separation sharpness J_{SS}(W) is an index value indicating the degree to which components of other sound sources are mixed into components of a sound source.

The geometric constraint J_{GC}(W) is an index value shown in expression (7).

J_{GC}(W)=|diag(WD−I)|² (7)

In expression (7), I denotes a unit matrix. That is, the geometric constraint J_{GC}(W) is an index value representing the degree of errors between sound-source-specific signals to be output and original sound source signals generated by the sound sources.

In this manner, it is possible to improve both the accuracy of separation between sound sources and the accuracy of estimation of spectrums of sound sources.

The sound source separation unit 122 extracts transfer functions corresponding to the respective sound source directions of sound sources indicated by the sound source localization information input from the sound source localization unit 121 from the preset set of transfer functions and generates a transfer function matrix D having the extracted transfer functions as elements incorporating both sound sources and channels. Rows and columns of this transfer function matrix D correspond to the channels and the sound sources (sound source directions). The sound source separation unit 122 calculates an initial separation matrix Wᵢₙᵢₜ shown in expression (8) on the basis of the generated transfer function matrix D.

Wᵢₙᵢₜ=[diag[D*D]]⁻¹D (8)

In expression (8), [ . . . ]⁻¹ represents the inverse of a matrix [ . . . ]. Therefore, if D*D is a diagonal matrix whose off-diagonal elements are all zero, the initial separation matrix Wᵢₙᵢₜ is a pseudoinverse of the transfer function matrix D.

The sound source separation unit 122 subtracts the sum of complex gradients J′_{SS}(Wₜ) and J′_{GC}(Wₜ) weighted by step sizes μ_{SS} and μ_{GC} from a separation matrix Wₜ at the current time t to calculate a separation matrix Wₜ₊₁ at the next time t+1 as shown in expression (9).

Wₜ₊₁=Wₜ−μ_{SS}J′_{SS}(Wₜ)−μ_{GC}J′_{GC}(Wₜ) (9)

The component μ_{SS}J′_{SS}(Wₜ)+μ_{GC}J′_{GC}(Wₜ) to be subtracted in expression (9) corresponds to an update amount ΔW. The complex gradient J′_{SS}(Wₜ) is derived by differentiating the separation sharpness J_{SS} with respect to the input vector x. The complex gradient J′_{GC}(Wₜ) is derived by differentiating the geometric constraint J_{GC} with respect to the input vector x.

Then, the sound source separation unit 122 multiplies the input vector x by the calculated separation matrix Wₜ₊₁ to calculate the output vector y. Here, the sound source separation unit 122 may calculate the output vector y by multiplying the input vector x by a separation matrix Wₜ₊₁ obtained upon determining that the separation matrix Wₜ₊₁ has converged. For example, the sound source separation unit 122 determines that the separation matrix Wₜ₊₁ has converged when the Frobenius norm of the update amount ΔW becomes equal to or less than a predetermined threshold value. Alternatively, the sound source separation unit 122 may determine that the separation matrix Wₜ₊₁ has converged when the ratio of the Frobenius norm of the separation amount Wₜ to the Frobenius norm of the update amount ΔW becomes equal to or less than a predetermined threshold ratio value.

The sound source separation unit 122 performs an inverse discrete Fourier transform on the transform coefficients which are the values of elements of channels of the output vector y obtained for each frequency to generate sound-source-specific signals in the time domain. The sound source separation unit 122 outputs the sound-source-specific signal of each sound source to the reverberation suppression unit 123.

As described above, the separation matrix W calculated by the sound source separation process depends on the initial separation matrix selected on the basis of transfer functions corresponding to estimated sound source directions. Therefore, when the operating environment of the audio processing device 1 differs from the acoustic environment in which the set of transfer functions set in the sound source separation unit 122 is acquired, a separation matrix W for separation into components coming from sound sources cannot be obtained with high accuracy. Thus, components of another sound source remain in a sound-source-specific signal of a sound source obtained by the separation. More specifically, the cost function J(W) which is to be minimized upon conversion of the separation matrix W does not always equal or approximate the minimum value or the time required until the separation matrix W converges may be longer than the time in which speech and speechless states are switched.

Therefore, the present embodiment allows a piece of profile data to be selected from a plurality of pieces of profile data set in advance for each acoustic environment and uses transfer functions included in the profile data changed by the selection to improve the accuracy of sound source separation.

### (Reverberation Suppression Process)

Next, a reverberation suppression process using a spectral subtraction method will be described as an exemplary reverberation suppression process.

The reverberation suppression unit 123 performs a discrete Fourier transform on a sound-source-specific signal of each sound source input from the sound source separation unit 122 for each frame to calculate a transform coefficient r(ω, i) in the frequency domain. Here, w and i indicate the frequency and the sound sources, respectively. The reverberation suppression unit 123 removes a reverberation component from the transform coefficient r(w, i) to calculate a transform coefficient e(ω, i) of a reverberation-suppressed sound as shown in expression (10).

|e(ω,i)|²=|r(ω,i)|²−δ_{b}|r(ω,i)|² (|r(ω,i)|²−δ_{b}|r(ω,i)|²>0) |e(ω,i)|²=β|r(ω,i)|²>0 (otherwise) (10)

In expression (10), δ_{b} represents a reverberation suppression coefficient in a predetermined frequency band b.

The reverberation suppression coefficient δ_{b} is used as a reverberation suppression parameter for frequencies ω belonging to the frequency band b. The reverberation suppression coefficient δb indicates the proportion of the power of the reverberation component in the power of a reverberation-added sound to which reverberation has been added. β represents a flooring coefficient. The flooring coefficient is a small positive value closer to 0 than to 1. Since the term β|r(ω,i)| is provided, a minimum amplitude of the reverberation-removed sound is maintained and therefore, for example, the occurrence of nonlinear noise such as musical noise is suppressed. The reverberation suppression unit 123 performs an inverse discrete Fourier transform on the calculated transform coefficient e(ω, i) for each sound source to generate sound-source-specific signals in which the reverberation component is suppressed.

The reverberation suppression unit 123 outputs the generated sound-source-specific signals to the noise suppression unit 124.

When determining the reverberation suppression coefficient δ_{b}, the array processing unit 12 may measure indoor transfer functions in the acoustic environment. Here, the array processing unit 12 reproduces a predetermined reference signal using a sound source installed at an arbitrary indoor position and acquires audio signals input from the sound collection unit 11 as response signals. The array processing unit 12 calculates an impulse response as an indoor transfer function expressed in the time domain using the reference signal and an acquired response signal of any of the channels. The array processing unit 12 extracts a late reflection component in which it is not possible to specify an individual reflected sound from the impulse response as a reverberation component. The array processing unit 12 calculates the power of the impulse response with respect to the power of the reverberation component for each predetermined frequency band b as a reverberation suppression coefficient δ_{b}.

Generally, the reverberation suppression coefficient δ_{b} depends on the frequency band b and therefore includes a plurality of parameters for each acoustic environment. Therefore, the profile selection unit 127 may multiply an original reverberation suppression coefficient δ_{b} by a common factor for frequency bands, which is a factor corresponding to a position designated on the basis of an operation signal, to calculate an adjusted reverberation suppression coefficient δ_{b}.

### (Noise Suppression Process)

Next, a noise suppression process using the HRLE method will be described as an exemplary noise suppression process.

The noise suppression unit 124 performs a discrete Fourier transform on a sound-source-specific signal of each sound source input from the reverberation suppression unit 123 for each frame to calculate a complex input spectrum Y(ω, 1) including transform coefficients in the frequency domain. Here, 1 denotes an index indicating each frame.

The noise suppression unit 124 calculates a logarithmic spectrum Y_{L}(ω, 1) represented by expression (11) from the complex input spectrum Y(ω, 1).

Y_{L}(ω,l)=20 log₁₀|Y(ω,l)| (11)

The noise suppression unit 124 determines a class I(ω, 1) to which the calculated logarithmic spectrum Y_{L}(ω, 1) belongs. The logarithmic spectrum Y_{L}(ω, 1) indicates the magnitude of the power of frame 1 at frequency ω. The class means one of the sections into which the range of values of the power is divided. I(ω, 1) is represented by expression (12).

I(ω,l)=floor(Y_{L}(ω,l)−Lₘᵢₙ)/Lₛₜₑₚ (12)

In expression (12), floor ( . . . ) denotes a floor function that gives the greatest integer equal to or less than a real number . . . . Lₘᵢₙ and Lₛₜₑₚ indicate the minimum level of a predetermined logarithmic spectrum Y_{L}(ω, 1) and the power width of each class, respectively.

The noise suppression unit 124 calculates the frequency N(ω, 1, i) of class i in the current frame 1 according to a relationship shown in expression (13).

N(ω,l,i)=γ·N(ω,l−1,i)+(1−γ)·δ(i−I(ω,l)) (13)

In expression (13), γ indicates a time attenuation coefficient. Here, γ=1−1/(τ·fₛ). τ indicates a predetermined time constant. fₛ indicates a predetermined sampling frequency. δ( . . . ) denotes the Dirac delta function. That is, the frequency N(ω, 1, i) is obtained by adding 1−γ to an attenuated value of the frequency N(ω, l−1, i) of class I(ω, l−1) of the power of a previous frame l−1 which is obtained by multiplying the frequency N(ω, l−1, i) by γ. Thus, the frequency N(ω, 1, I(ω, 1)) for each class I(ω, 1) is successively accumulated.

The noise suppression unit 124 calculates the sum of the frequencies N(ω, 1, i) of classes from the lowest class 0 to class i as a cumulative frequency S(ω, 1, i) of the class i.

The noise suppression unit 124 determines class i, which gives a cumulative frequency S(ω, 1, i) most approximate to a cumulative frequency S(ω, 1, Imax)·Lx corresponding to a cumulative frequency Lx given as the noise suppression parameter, as an estimated class Iₓ(ω, 1). The estimated class Iₓ(ω, 1) has a relationship with the cumulative frequency S(ω, 1, i) as shown in expression (14).

Iₓ(ω,l)=argminᵢ[S(ω,l,Iₘₐₓ)·Lx−S(ω,l,i)] (14)

In expression (14), arg minᵢ[ . . . ] indicates i which minimizes . . . .

The noise suppression unit 124 converts the determined estimated class Iₓ(ω, 1) into a logarithmic level λ_{HRLE}(ω, 1) shown in expression (15).

λ_{HRLE}(ω,l)=Lₘᵢₙ+Lₛₜₑₚ·Iₓ(ω,l) (15)

The noise suppression unit 124 converts the logarithmic level λ_{HRLE}(ω, 1) into a linear domain to calculate a noise power λ(ω, 1) shown in expression (16).

λ(ω,l)=10^{(λ}^{_{HRLE}}^{(ω,l)/20)} (16)

The noise suppression unit 124 calculates a gain G_{SS}(ω, L) shown in expression (17) from the noise power λ(ω, 1) and a power spectrum |Y(ω, 1)|² obtained on the basis of the complex input spectrum Y(ω, 1).

G_{SS}(ω,l)=max[\sqrt{{|Y(ω,l)|²−λ*ω,l)}/|Y(ω,l)|²},ε] (17)

In expression (17), max (δ, ≥9) indicates the greater of the real numbers δ and ε. c indicates a predetermined minimum value of the gain G_{SS}(ω, 1). The left term of max in expression (17) indicates the square root of the ratio of a power spectrum |Y(ω, 1)⊕²−λ(ω, 1) from which noise components relating to frequency ω have been removed in the frame 1 to a power spectrum |Y(ω, 1)|² from which no noise components have been removed.

Then, the noise suppression unit 124 multiplies the complex input spectrum Y(ω, 1) by the calculated gain G_{SS}(ω, 1) to calculate a complex noise-removed spectrum X′(ω, 1). The complex noise-removed spectrum X′(ω, 1) represents a complex spectrum obtained by subtracting a noise power indicating the noise component from the complex input spectrum Y(ω, 1).

The noise suppression unit 124 performs an inverse discrete Fourier transform on the complex noise-removed spectrum X′(ω, 1) to generate sound-source-specific signals in which the noise component is suppressed. The noise suppression unit 124 outputs the sound-source-specific signal of each sound source in which the noise component is suppressed to one or both of the voice recognition unit 16 and the data storage unit 17.

According to the HRLE method, by setting the cumulative frequency Lx in advance, it is possible to estimate a background noise component in the operating environment of the audio processing device 1 without previously performing measurement. As the cumulative frequency Lx increases, the amount of suppression of the noise component increases but distortion of the speech also increases.

Therefore, when the cumulative frequency Lx for each acoustic environment is set as the noise suppression parameter, a cumulative frequency Lx at which the subjective sound quality is maximized is determined considering both sound quality improvement due to the amount of suppression and sound quality deterioration due to distortion. In addition, the noise suppression unit 124 acquires the noise power λ(ω, 1) obtained on the basis of the cumulative frequency Lx set in the acoustic environment as background noise information and stores the acquired background noise information as corresponding acoustic environment information in the profile storage unit 126. The noise power λ(ω, 1) of frequencies ω indicates background noise characteristics in the acoustic environment.

### (Audio Processing)

Next, audio processing according to the present embodiment will be described.

FIG. 5 is a flowchart showing the audio processing according to the present embodiment.

(Step S202) The profile selection unit 127 selects profile data relating to one acoustic environment from profile data relating to a plurality of acoustic environments stored in advance in the profile storage unit 126. An example of the profile selection will be described later. Thereafter, the procedure proceeds to a process of step S204.

(Step S204) The sound collection unit 11 collects audio signals of N channels. The collected audio signals of N channels are input to the sound source localization unit 121. Thereafter, the procedure proceeds to a process of step S206.

(Step S206) Using a set of transfer functions set by the profile selection unit 127, the sound source localization unit 121 performs a sound source localization process on the audio signals of N channels at intervals of a predetermined period to estimate the direction of each sound source. Thereafter, the procedure proceeds to a process of step S208.

(Step S208) The sound source separation unit 122 performs a sound source separation process on the audio signals of N channels on the basis of transfer functions corresponding to the estimated sound source directions among a set of transfer functions set by the profile selection unit 127 to generate a sound-source-specific signal of each sound source. Thereafter, the procedure proceeds to a process of step S210.

(Step S210) The reverberation suppression unit 123 performs the reverberation suppression process on the sound-source-specific signal of each sound source using a reverberation suppression parameter set by the profile selection unit 127. Thereafter, the procedure proceeds to a process of step S212.

(Step S212) The noise suppression unit 124 performs a noise suppression process on the sound-source-specific signal of each sound source in which reverberation has been suppressed using a noise suppression parameter set by the profile selection unit 127. Thereafter, the procedure shown in FIG. 5 ends.

In the procedure shown in FIG. 5, the process of step S202 is generally performed asynchronously with the processes of steps S204 to S212. The processes of steps S204 to S212 are repeated with the lapse of time. The process of step S210 may also precede the process of step S212.

### (Profile Selection)

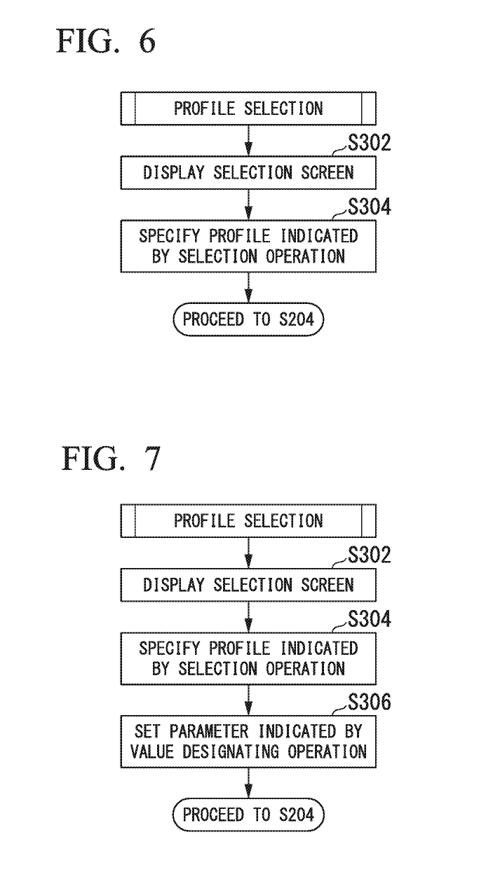

Next, an example of the profile selection according to the present embodiment will be described. FIG. 6 is a flowchart showing a first example of the profile selection according to the present embodiment.

(Step S302) The profile selection unit 127 causes the display unit 15 to display a profile selection screen upon activation or when display of the selection screen is indicated. Thereafter, the profile selection unit 127 proceeds to a process of step S304.

(Step S304) The profile selection unit 127 specifies a profile indicated on the basis of a selection operation. For example, the profile selection unit 127 specifies a profile corresponding to acoustic environment information displayed on the profile selection screen in response to pressing of the “OK” button as the selection operation. The profile selection unit 127 sets a set of transfer functions included in the determined profile data in the sound source localization unit 121 and the sound source separation unit 122. The profile selection unit 127 sets acquired source detection, noise suppression, and reverberation suppression parameters in the sound source localization unit 121, the noise suppression unit 124, and the reverberation suppression unit 123, respectively.

Thereafter, the procedure proceeds to the process of step S204 (of FIG. 5).

FIG. 7 is a flowchart showing a second example of the profile selection according to the present embodiment. The procedure shown in FIG. 7 includes a process of step S306 in addition to the procedure shown in FIG. 6.

(Step S306) The profile selection unit 127 specifies an audio processing parameter and a value thereof indicated by a value designation operation and sets the specified audio processing parameter in a corresponding functional unit. For example, the profile selection unit 127 specifies the type of a parameter indicated by a pointer of a slider as the value designation operation and a value of the parameter corresponding to the position of the pointer.

Here, the type of parameter indicates one of the sound source detection parameter, the noise suppression parameter, and the reverberation suppression parameter. The corresponding function unit is a functional unit that performs processing using the parameter. That is, the corresponding function unit indicates the sound source localization unit 121, the noise suppression unit 124, and the reverberation suppression unit 123 respectively for the sound source detection parameter, the noise suppression parameter, and the reverberation suppression parameter. Thereafter, the procedure proceeds to the process of step S204 (of FIG. 5).

The examples shown in FIGS. 6 and 7 have been described with reference to the case in which profile data is selected according to the user's operation, but the present invention is not limited to this. In a third example described next, the profile selection unit 127 selects profile data on the basis of a selection history. The selection history is information which is stored in the profile storage unit 126 and indicates profile data selected up to that point in time.

In the selection history, information of the date and time when the profile data is selected may be recorded in association with the information of the profile data.

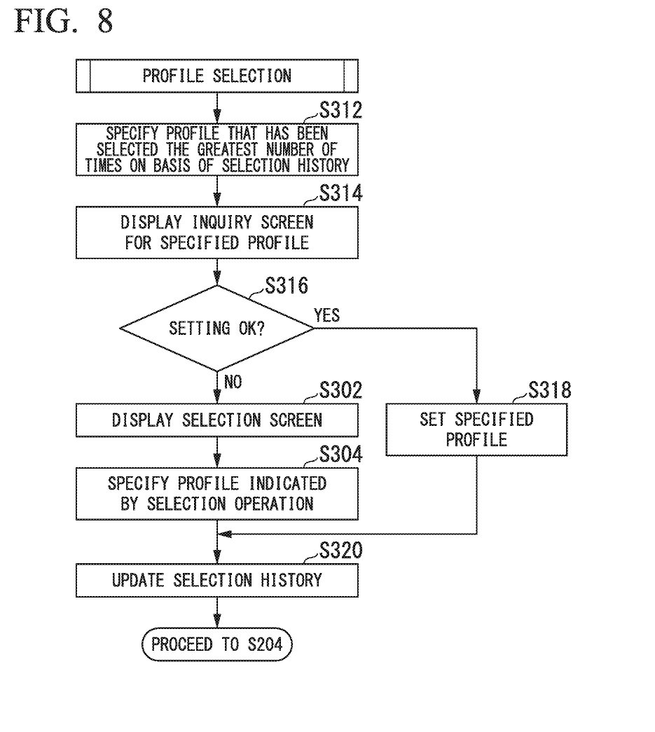

FIG. 8 is a flowchart showing a third example of the profile selection according to the present embodiment.

(Step S312) The profile selection unit 127 refers to the selection history stored in the profile storage unit 126 and counts the number of selections up to that point in time for each piece of profile data. The profile selection unit 127 specifies a piece of profile data with the greatest number of selections counted. Thereafter, the profile selection unit 127 proceeds to a process of step S314.

(Step S314) The profile selection unit 127 causes the display unit 15 to display an inquiry screen for the specified piece of profile data. The inquiry screen includes an inquiry message as to whether or not to permit setting of the profile data, an OK button for indicating that the setting is permitted, and an NG button for indicating that the setting is not permitted. The inquiry screen may include information of a part of acoustic environment information associated with the piece of profile data (for example, information such as the name, size, shape, or wall surface reflectance) as information indicating the piece of profile data. Thereafter, the profile selection unit 127 proceeds to a process of step S316.

(Step S316) When it is indicated by an operation signal that the setting is permitted (YES in step S316), the profile selection unit 127 proceeds to a process of step S318. (Step S316) When it is indicated by an operation signal that the setting is not permitted (step S316: NO), the profile selection unit 127 proceeds to a process of step S302. After the process of step S302 and the process of step S304 are completed, the profile selection unit 127 proceeds to a process of step S320.

(Step S318) The profile selection unit 127 sets a set of transfer functions included in the specified piece of profile data in both the sound source localization unit 121 and the sound source separation unit 122. The profile selection unit 127 sets acquired sound source detection, noise suppression, and reverberation suppression parameters in the sound source localization unit 121, the noise suppression unit 124, and the reverberation suppression unit 123, respectively. Thereafter, the profile selection unit 127 proceeds to a process of step S320.

(Step S320) The profile selection unit 127 updates the selection history by adding both information indicating the selected piece of profile data and information regarding that point in time to the selection history. The selected piece of profile data is a piece of profile data selected by the profile selection unit 127 in step S312 if it is indicated in step S316 that the setting is permitted, and is a piece of profile data indicated by a selection operation in step S304 if it is indicated in step S316 that the setting is not permitted. Thereafter, the profile selection unit 127 proceeds to the process of step S204 (of FIG. 5).

In a fourth example described next, the profile selection unit 127 selects profile data on the basis of background noise characteristics in an operating environment of the audio processing device 1. This is based on the premise that background noise information of a corresponding acoustic environment is included in the background noise information and is stored in the profile storage unit 126 in association with profile data relating to the acoustic environment.

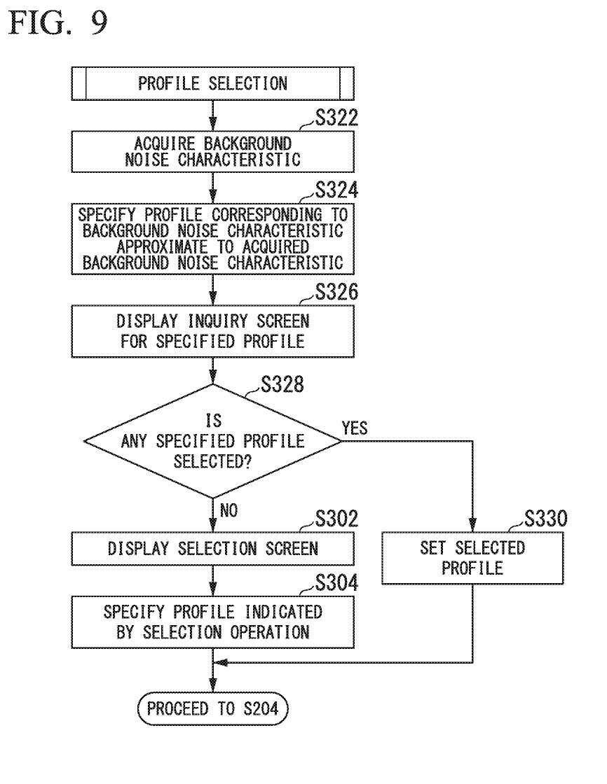

FIG. 9 is a flowchart showing a fourth example of the profile selection according to the present embodiment.

(Step S322) The noise suppression unit 124 acquires background noise characteristics of a background noise component included in a sound-source-specific signal of one sound source input from the sound source separation unit 122. For example, the noise suppression unit 124 calculates a noise power as a feature amount indicating the background noise characteristics, for example, using the HRLE method described above. The noise suppression unit 124 may use an audio signal of one of the channels input from the sound collection unit 11 instead of the sound-source-specific signal. The noise suppression unit 124 outputs background noise information indicating the acquired background noise characteristic to the profile selection unit 127. Thereafter, the procedure proceeds to a process of step S324.

(Step S324) The profile selection unit 127 calculates an index value indicating the degree of approximation between a background noise characteristic indicated by the background noise information input from the noise suppression unit 124 and a background noise characteristic indicated by background noise information included in each of a plurality of pieces of acoustic environment information stored in the profile storage unit 126. The profile selection unit 127 uses, for example, a Euclidean distance as the index value. The Euclidean distance is an index value indicating that the two are more closely approximate to each other as the value decreases. The profile selection unit 127 specifies a piece of profile data corresponding to acoustic environment information including background noise information indicating a background noise characteristic most closely approximate to the background noise characteristic indicated by the background noise information input from the noise suppression unit 124. Thereafter, the profile selection unit 127 proceeds to a process of step S326.

(Step S326) The profile selection unit 127 causes the display unit 15 to display an inquiry screen for the specified piece of profile data. A process regarding this step may be the same as the process shown in step S314. Thereafter, the procedure proceeds to a process of step S328.

(Step S328) When it is indicated by an operation signal that the setting is permitted (YES in step S328), the profile selection unit 127 proceeds to a process of step S330. When it is indicated by an operation signal that the setting is not permitted (step S328: NO), the profile selection unit 127 proceeds to a process of step S302. After the process of step S302 and the process of step S304 are completed, the profile selection unit 127 proceeds to the process of step S204 (of FIG. 5).

(Step S330) The profile selection unit 127 sets a set of transfer functions included in the specified piece of profile data in the sound source localization unit 121 and the sound source separation unit 122. The profile selection unit 127 sets acquired sound source detection, noise suppression, and reverberation suppression parameters in the sound source localization unit 121, the noise suppression unit 124, and the reverberation suppression unit 123, respectively. Thereafter, the profile selection unit 127 proceeds to the process of step S204 (of FIG. 5).

In step S324, the profile selection unit 127 may also specify a plurality of pieces of profile data corresponding to a plurality of pieces of acoustic environment information including a predetermined number of pieces of background noise information counted from a piece of background noise information indicating a background noise characteristic most closely approximate to the background noise characteristic indicated by the background noise information input from the noise suppression unit 124 in descending order of the degree of approximation. Then, the processes of steps S326 and S328 may be repeated for the pieces of profile data specified in that order. As a result, pieces of profile data are selected in descending order of the degree of approximation to the background noise characteristic of the operating environment.

In the procedures of FIGS. 8 and 9, after the process of step S304, the profile selection unit 127 may proceed to the process of step S306 shown in FIG. 7 and may then perform the process of step S204 (of FIG. 5).

As described above, in the reverberation suppression process, the distortion of the speech increases as the amount of reverberation suppression increases and therefore there is an amount of reverberation suppression at which the human's subjective sound quality is the highest under a certain reverberation level. Under a certain reverberation level, the amount of reverberation suppression at which the subjective sound quality is the highest is greater than the amount of reverberation suppression at which the voice recognition rate is the highest. Similarly, in the noise suppression process, the distortion of the speech increases as the amount of noise suppression increases. Under a certain background noise level, the amount of noise suppression at which the subjective sound quality is the highest is greater than the amount of noise suppression at which the voice recognition rate is the highest.

Therefore, in the profile setting, noise suppression parameters and reverberation suppression parameters of two stages are determined for each piece of acoustic environment information and included in corresponding profile data. Each stage is associated with a voice recognition mode or a recording mode. A noise suppression parameter corresponding to the voice recognition mode is set to a value with which the amount of noise suppression and thus the distortion are smaller than with a value to which a noise suppression parameter corresponding to the recording mode is set. A reverberation suppression parameter corresponding to the voice recognition mode is set to a value with which the amount of reverberation suppression and thus the distortion are smaller than with a value to which a reverberation suppression parameter corresponding to the recording mode is set.

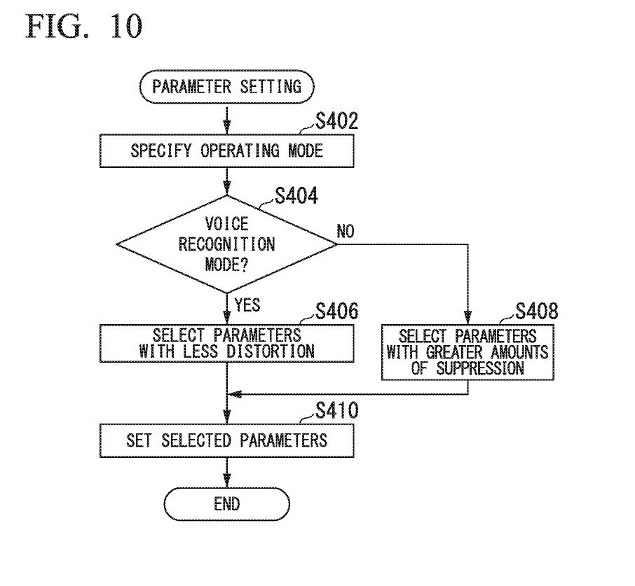

The profile selection unit 127 selects a reverberation suppression parameter and a noise suppression parameter corresponding to the operating mode indicated by an operation signal from two-stage reverberation suppression parameters and two-stage noise suppression parameters included in the piece of profile data selected through the above processes. In the following description, the reverberation suppression parameter and the noise suppression parameter corresponding to the voice recognition mode are referred to as reverberation suppression parameter 1 and noise suppression parameter 1, respectively. The reverberation suppression parameter and the noise suppression parameter corresponding to the recording mode are referred to as reverberation suppression parameter 2 and noise suppression parameter 2, respectively. More specifically, the profile selection unit 127 performs a parameter setting procedure shown in FIG. 10.

(Step S402) The profile selection unit 127 specifies through its own function an operating mode as indicated by an operation signal input from the operation input unit 14. Thereafter, the profile selection unit 127 proceeds to a process of step S404.

(Step S404) When the operating mode specified by the profile selection unit 127 is the voice recognition mode (YES in step S404), the profile selection unit 127 proceeds to a process of step S406. When the operating mode specified by the profile selection unit 127 is the recording mode (NO in step S404), the profile selection unit 127 proceeds to a process of step S408.

(Step S406) The profile selection unit 127 selects the reverberation suppression parameter 1 and the noise suppression parameter 1 as parameters with less speech distortion. Thereafter, the profile selection unit 127 proceeds to a process of step S410.

(Step S408) The profile selection unit 127 selects the reverberation suppression parameter 2 and the noise suppression parameter 2 as parameters with greater amounts of noise suppression and reverberation suppression. The profile selection unit 127 proceeds to a process of step S410.

(Step S410) The profile selection unit 127 outputs the selected reverberation suppression parameter and the selected noise suppression parameter to the reverberation suppression unit 123 and the noise suppression unit 124, respectively. The reverberation suppression unit 123 and the noise suppression unit 124 perform a reverberation suppression process and a noise suppression process using the reverberation suppression parameter and the noise suppression parameter input from the profile selection unit 127, respectively. Thereafter, the procedure shown in FIG. 10 ends.

It is to be noted that the reverberation suppression unit 123 may perform reverberation suppression processes respectively using the two-stage reverberation suppression parameters in parallel. Similarly, the noise suppression unit 124 may perform noise suppression processes respectively using the two-stage noise suppression parameters in parallel. When the conference mode is specified as the operating mode, the profile selection unit 127 selects the reverberation suppression parameter 1, the noise suppression parameter 1, the reverberation suppression parameter 2, and the noise suppression parameter 2. Then, the profile selection unit 127 outputs both the reverberation suppression parameter 1 and the reverberation suppression parameter 2 to the reverberation suppression unit 123 and outputs both the noise suppression parameter 1 and the noise suppression parameter 2 to the noise suppression unit 124. A sound-source-specific signal obtained by performing a reverberation suppression process using the reverberation suppression parameter 1 and performing a noise suppression process using the noise suppression parameter 1 is input to the voice recognition unit 16. A sound-source-specific signal obtained by performing a reverberation suppression process using the reverberation suppression parameter 2 and performing a noise suppression process using the noise suppression parameter 2 is input to the data storage unit 17. Therefore, it is possible to simultaneously achieve an improvement in the voice recognition rate and an improvement in the subjective quality of recorded sound.

As described above, the audio processing device 1 according to the present embodiment includes a sound source localization unit (for example, the sound source localization unit 121) configured to determine respective directions of sound sources from audio signals of a plurality of channels. The audio processing device 1 includes a setting information selection unit (for example, the profile selection unit 127) configured to select a piece of setting information from a setting information storage unit (for example, the profile storage unit 126) configured to store setting information (for example, profile data) including transfer functions of directions in advance for each acoustic environment.

The audio processing device 1 includes a sound source separation unit (for example, the sound source separation unit 122) configured to separate the audio signals of the plurality of channels into respective sound-source-specific signals of sound sources by applying a separation matrix based on transfer functions included in the piece of setting information selected by the setting information selection unit.

According to this configuration, transfer functions acquired in any acoustic environment can be selected from transfer functions used to calculate separation matrices acquired in various acoustic environments. By switching to the selected transfer functions, it is possible to suppress a failure in the sound source separation or a reduction in the accuracy of sound source separation due to the use of fixed transfer functions.

Further, at least one of the shape, the size, and the wall surface reflectance of a space in which sound sources are installed differs for each of the acoustic environments.

According to this configuration, transfer functions corresponding to one of the shape, the size, and the wall surface reflectance of the space, which are acoustic environment variation factors, are set. Therefore, it is possible to easily select transfer functions by using the shape, the size, and the wall surface reflectance of the space, which are the variation factors, as clues.

The setting information selection unit is configured to cause a display unit to display information indicating acoustic environments and to select setting information corresponding to one of the acoustic environments on the basis of an operation input.

According to this configuration, the user can arbitrarily select transfer functions used to calculate the separation matrix by referring to the acoustic environment without performing a complicated setting task.

The setting information selection unit is configured to record history information indicating the selected piece of setting information, to count the frequency of selection of each piece of setting information on the basis of the history information, and to select a piece of setting information from the setting information storage unit on the basis of the counted frequency.

According to this configuration, without the user performing a special operation, it is possible to select transfer functions included in a piece of setting information on the basis of the frequency of selection of the piece of setting information in the past. In the case in which a piece of setting information including transfer functions giving high sound source separation accuracy in the operating environment of the audio processing device 1 has been frequently selected in the past, it is possible to suppress a failure in the sound source separation or a reduction in the accuracy of sound source separation by using the selected transfer functions.

The setting information includes background noise information regarding a background noise characteristic in the acoustic environment and the setting information selection unit is configured to analyze a background noise characteristic in a collected audio signal and to select a piece of setting information on the basis of the analyzed background noise characteristic.

According to this configuration, transfer functions acquired in an acoustic environment having a background noise characteristic approximate to the background noise characteristic of the operating environment of the audio processing device 1 are selected without the user performing a special operation. Therefore, it is possible to reduce an influence due to differences in background noise between acoustic environments and thus it is possible to suppress a failure in the sound source separation or a reduction in the accuracy of sound source separation.

The setting information selection unit is configured to determine one or both of a reverberation suppression parameter and a noise suppression parameter as a parameter relating to the amount of speech emphasis included in each of the sound-source-specific signals on the basis of an operation input.

According to this configuration, it is possible to arbitrarily adjust the amount of reverberation or noise suppression as the amount of speech emphasis designated in the setting information.

### Second Embodiment

Hereinafter, a second embodiment of the present invention will be described with reference to the drawings. The same elements as in the first embodiment are denoted by the same reference signs and the descriptions thereof in the first embodiment apply herein.

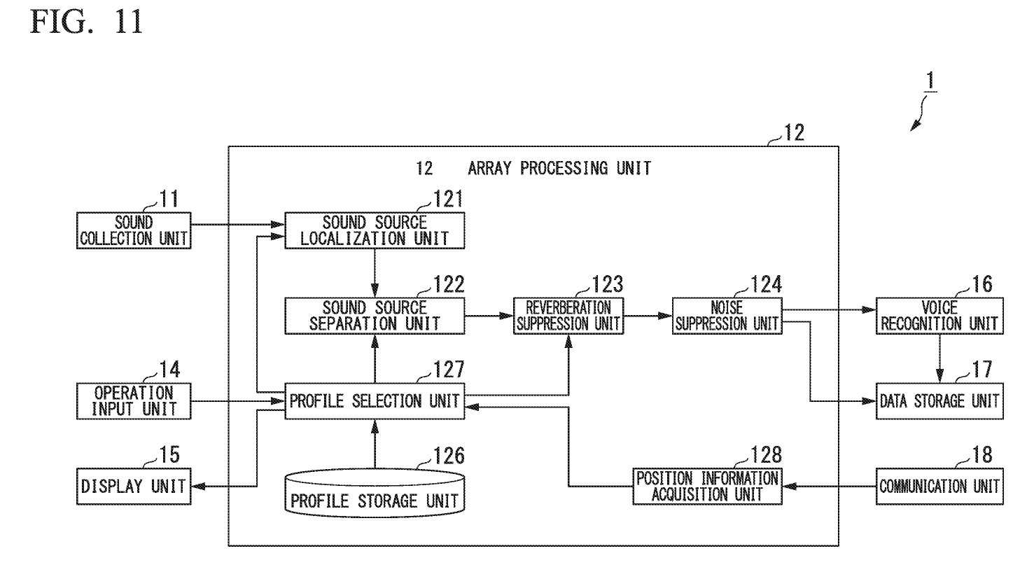

FIG. 11 is a block diagram showing an exemplary configuration of an audio processing device 1 according to the present embodiment.

The audio processing device 1 includes a sound collection unit 11, an array processing unit 12, an operation input unit 14, a display unit 15, a voice recognition unit 16, a data storage unit 17, and a communication unit 18.

The array processing unit 12 includes a sound source localization unit 121, a sound source separation unit 122, a reverberation suppression unit 123, a noise suppression unit 124, a profile storage unit 126, a profile selection unit 127, and a position information acquisition unit 128.

In the present embodiment, in the profile storage unit 126, acoustic environment information associated with profile data includes position information indicating a position of the acoustic environment.

The position information indicates a representative position of a space that forms an acoustic environment in which there is a possibility that the sound collection unit 11 or the audio processing device 1 integrated with the sound collection unit 11 is installed. The space is a specific indoor space such as a conference room, an office room, or a laboratory. Base station devices constituting a wireless communication network are installed in such spaces. The base station devices are, for example, access points constituting a wireless local area network (LAN) or small cells in a public wireless communication network. Identification information of each installed base station device may be included as the position information. For example, a basic service set identity (BSS ID) defined in IEEE 802.15, an eNodeB ID defined in long term evolution (LTE), or the like may be used as the identification information.

Therefore, profile data for each piece of acoustic environment information includes a set of transfer functions, a sound source detection parameter, a noise suppression parameter, and a reverberation suppression parameter acquired in a corresponding space.

The communication unit 18 wirelessly connects to other devices different from the audio processing device 1 using a predetermined communication method to transmit or receive various types of data. Upon discovering an available network before establishing a connection therewith, the communication unit 18 detects notification information in a signal wirelessly received from a base station device. The notification information is information that the base station device transmits at predetermined time intervals to provide a notification of which network the base station device belongs to and includes identification information of the base station device itself. The communication unit 18 outputs the detected notification information to the position information acquisition unit 128.

The position information acquisition unit 128 extracts the identification information of the base station device as the position information from the notification information input from the communication unit 18. That is, the identification information is used as information indicating the position of the space in which the audio processing device 1 is installed at that time. The position information acquisition unit 128 outputs the acquired position information to the profile selection unit 127.

The profile selection unit 127 selects a piece of acoustic environment information including position information matching the position information input from the position information acquisition unit 128 from acoustic environment information stored in the profile storage unit 126. The profile selection unit 127 specifies a piece of profile data associated with the selected piece of acoustic environment information. Then, the profile selection unit 127 outputs a set of transfer functions included in the specified piece of profile data to the sound source localization unit 121 and the sound source separation unit 122. The profile selection unit 127 outputs a sound source detection parameter, a noise suppression parameter, and a reverberation suppression parameter included in the specified piece of profile data to the sound source localization unit 121, the noise suppression unit 124, and the reverberation suppression unit 123, respectively.

Next, an example of the profile selection according to the present embodiment will be described.

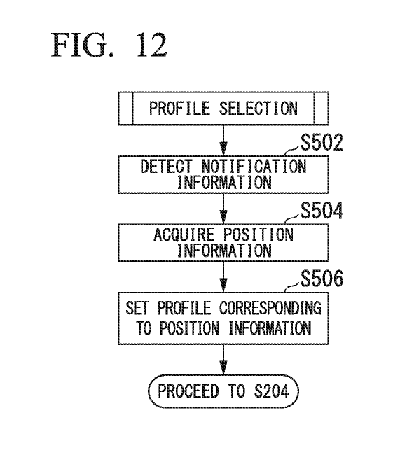

FIG. 12 is a flowchart showing an example of the profile selection according to the present embodiment.

(Step S502) The communication unit 18 detects notification information from a signal received from a base station device. Thereafter, the procedure proceeds to a process of step S504.

(Step S504) The position information acquisition unit 128 acquires identification information of the base station device as position information from notification information detected by the communication unit 18. Thereafter, the procedure proceeds to a process of step S506.

(Step S506) The profile selection unit 127 selects a piece of profile data which is associated with acoustic environment information including position information matching the position information acquired by the position information acquisition unit 128 from profile data stored in the profile storage unit 126. The profile selection unit 127 outputs a set of transfer functions included in the selected piece of profile data to the sound source localization unit 121 and the sound source separation unit 122. The profile selection unit 127 outputs a sound source detection parameter, a noise suppression parameter, and a reverberation suppression parameter included in the selected piece of profile data to the sound source localization unit 121, the noise suppression unit 124, and the reverberation suppression unit 123, respectively. Thereafter, the procedure proceeds to the process of step S204 (of FIG. 5).

The above description has been exemplified by the case in which the position information acquisition unit 128 acquires identification information indicating a base station device included in a wireless communication system as position information, but the present invention is not limited thereto. The position information acquisition unit 128 only needs to be able to acquire a representative position of a space forming each acoustic environment. For example, in each space in which there is a possibility that the audio processing device 1 is used, there may be preinstalled a transmitter which delivers identification information indicating the space by infrared light. Then, from a signal received by infrared ray, the position information acquisition unit 128 may acquire the identification information indicating the transmitter which has transmitted the signal as the position information.

As described above, the audio processing device 1 according to the present embodiment further includes a position information acquisition unit that acquires the position of the audio processing device 1 itself. The setting information selection unit selects setting information corresponding to an acoustic environment at the position indicated by the position information.

According to this configuration, transfer functions corresponding to the acoustic environment in the operating environment of the audio processing device 1 are used for sound source separation without the user performing a special operation. Therefore, it is possible to suppress a failure in the sound source separation or a reduction in the accuracy of sound source separation.

It is to be noted that a part of the audio processing device 1 according to the above embodiments or modifications thereof, for example, some or all of the sound source localization unit 121, the sound source separation unit 122, the reverberation suppression unit 123, the noise suppression unit 124, the profile selection unit 127, the position information acquisition unit 128, the voice recognition unit 16, and the data storage unit 17 may be realized by a computer. In this case, the same may be realized by recording a program for realizing corresponding control functions on a computer readable recording medium and causing a computer system to read and execute the program recorded on the recording medium. The “computer system” referred to here is a computer system which is incorporated in the audio processing device 1 and which includes an OS or hardware such as peripheral devices. Further, the “computer-readable recording medium” refers to a storage medium such as a flexible disk, a magneto-optical disk, a ROM, a portable medium such as a CD-ROM, or a hard disk provided in the computer system. Furthermore, the “computer-readable recording medium” may include a medium that dynamically holds the program for a short period of time such as a communication wire in the case in which the program is transmitted via a network such as the Internet or a communication line such as a telephone line or a medium that holds the program for a certain period of time such as a volatile memory in a computer system serving as a server or a client in that case. Further, the above-described program may be one for realizing some of the functions described above and may also be one for realizing the functions described above in combination with a program already recorded in the computer system.

All or a part of the audio processing device 1 in the above embodiments and modifications thereof may also be realized as an integrated circuit such as large scale integration (LSI). Each of the functional blocks of the audio processing device 1 may be individually implemented as a processor or all or some thereof may be integrated into a processor. Further, the method of forming an integrated circuit is not limited to LSI and may be realized by a dedicated circuit or a general-purpose processor. Furthermore, when an integrated circuit technology replacing LSI emerges due to advances in semiconductor technologies, an integrated circuit based on the technology may be used.

Although the embodiments of the present invention have been described in detail with reference to the drawings, specific configurations are not limited to those described above and various design modifications or the like can be made without departing from the spirit of the present invention.

What is claimed is:

1. An audio processing device, comprising:
a sound source localization unit configured to determine respective directions of sound sources from audio signals of a plurality of channels;
a setting information selection unit configured to select a setting information from a setting information storage unit configured to store setting information including transfer functions of directions in advance for each acoustic environment; and
a sound source separation unit configured to separate the audio signals of the plurality of channels into respective sound-source-specific signals of sound sources by applying a separation matrix based on transfer functions included in the setting information selected by the setting information selection unit.

2. The audio processing device according to claim 1, wherein at least one of a shape, a size, and a wall surface reflectance of a space in which sound sources are installed differs for each of the acoustic environments.

3. The audio processing device according to claim 1, wherein the setting information selection unit is configured to cause a display unit to display information indicating acoustic environments and to select setting information corresponding to one of the acoustic environments on the basis of an operation input.

4. The audio processing device according to claim 1, wherein the setting information selection unit is configured to record history information indicating the selected setting information, to count a frequency of selection of each setting information on the basis of the history information, and to select the setting information from the setting information storage unit on the basis of the counted frequency.

5. The audio processing device according to claim 1, wherein the setting information includes background noise information regarding a background noise characteristic in the acoustic environment and the setting information selection unit is configured to analyze a background noise characteristic in a collected audio signal and to select the setting information from the setting information storage unit on the basis of the analyzed background noise characteristic.

6. The audio processing device according to claim 1, further comprising a position information acquisition unit configured to acquire a position of the audio processing device,
wherein the setting information selection unit is configured to select setting information corresponding to an acoustic environment at the position.

7. The audio processing device according to claim 1, wherein the setting information selection unit is configured to determine an amount of speech emphasis included in each of the sound-source-specific signals on the basis of an operation input.

8. An audio processing method for an audio processing device, the audio processing method comprising:
a sound source localization process including determining respective directions of sound sources from audio signals of a plurality of channels;
a setting information selection process including selecting a setting information from a setting information storage unit configured to store setting information including transfer functions of directions in advance for each acoustic environment; and
a sound source separation process including separating the audio signals of the plurality of channels into respective sound-source-specific signals of sound sources by applying a separation matrix based on transfer functions included in the setting information selected in the setting information selection process.

9. A program causing a computer for an audio processing device to perform:
a sound source localization procedure including determining respective directions of sound sources from audio signals of a plurality of channels;
a setting information selection procedure including selecting a setting information from a setting information storage unit configured to store setting information including transfer functions of directions in advance for each acoustic environment; and
a sound source separation procedure including separating the audio signals of the plurality of channels into respective sound-source-specific signals of sound sources by applying a separation matrix based on transfer functions included in the setting information selected in the setting information selection procedure.
